(19) United States
(12) Patent Application Publication
(10) Pub. No.: US 2014/0183289 A1
(43) Pub. Date: Jul. 3, 2014

(54) Comminution and/or Removal of Liquid from a Material

(71) Applicants: Peter Joseph Scales, Melbourne (AU); Antoinette Tordesillas, Melbourne (AU); Anthony Dirk Stickland, Melbourne (AU); Robin John Batterham, Melbourne (AU)

(72) Inventors: Peter Joseph Scales, Melbourne (AU); Antoinette Tordesillas, Melbourne (AU); Anthony Dirk Stickland, Melbourne (AU); Robin John Batterham, Melbourne (AU)

(73) Assignee: THE UNIVERSITY OF MELBOURNE, Melbourne (AU)

(21) Appl. No.: 14/232,631

(22) PCT Filed: Jul. 13, 2012
(86) PCT No.: PCT/AU2012/000844

§ 371 Date: Mar. 7, 2014

(30) Foreign Application Priority Data
Jul. 14, 2011 (AU) 2011902819

(51) Int. Cl. B02C 4/28; B02C 4/02

(52) U.S. Cl. CPC B02C 4/28; B02C 4/02
USPC 241/3; 241/101.4

(57) ABSTRACT

There is disclosed a material processing method wherein a material is fed between a pair of opposed moving surfaces which converge such that a nip is defined therebetween, whereby the material is drawn into the nip to be compressed or compacted between the surfaces, and thence output from between the surfaces, the method comprising subjecting the material to an asymmetric and/or non uniform flow condition between the surfaces to effect shearing in the material in a direction generally parallel to the direction of flow of the material between the surfaces.

The present invention relates to reducing the energy required for comminution of materials, and has application, but is not necessarily limited, to bulk materials processing. The invention can also be applied for the purpose of more efficient removal of moisture/liquid from a material, and particularly for dewatering. The material may be any material that requires size reduction or moisture reduction. By way of example, the material may be a mined material such as mineral ore or a carbonaceous material such as coal.

High pressure grinding rolls are commonly used in the mining industry for comminution of mined materials. Preferred embodiments of the invention provide a comminution method which is more efficient, i.e. requires a lower energy input, than current comminution methods.

According to one aspect of the present invention, there is provided a material processing method wherein a material is fed between a pair of opposed moving surfaces which converge such that a nip is defined therebetween, whereby the material is drawn into the nip to be compressed or compacted between the surfaces, and thence output from between the surfaces, the method comprising subjecting the material to an asymmetric and/or non-uniform flow condition between the surfaces to effect shearing in the material in a direction generally parallel to the direction of flow of the material between the surfaces.

According to another aspect of the present invention, there is provided a material processing method wherein a material is fed between a pair of opposed moving surfaces which converge such that a nip is defined therebetween, so that the material is compressed or compacted between the surfaces, and thence output from between the surfaces, and wherein a draw of the material into the nip is uneven about a plane through the nip extending parallel to a direction of flow of the material between the surfaces, to effect shearing in the material.

Generally speaking, the shearing will be effected in a direction generally parallel to the direction of movement of the surfaces at the nip.

In the preferred embodiments of the invention, the surfaces are circulated/circuited/circuiting.

The uneven/non-uniform/asymmetric draw may be effected, for example, by virtue of any one or more of the following: a difference in speed of the surfaces; a difference in configuration of the surfaces; a difference in a hydrostatic pressure and/or density profile in the material across the nip; asynchronous movement of the surfaces, which movement may be stepped and/or intermittent; a stock or charge of material being forced in an even manner against the surfaces adjacent/at an inlet to the nip.

The plane may be a central plane through the nip.

The surfaces may move intermittently or continuously. The surfaces may move asynchronously.

The intermittent motion/rotation could be an indexing or pulsating motion, and could be effected by way of a ratchet or the like.

In one embodiment of the invention, the surfaces are symmetrically arranged about a central plane passing through the nip. Preferably, in such an embodiment the surfaces move asynchronously and/or at different speeds.

In preferred embodiments of the invention, the material is drawn between opposed counter-rotating rollers. The surfaces may be surfaces of the rollers or surfaces of belts which are trained around the rollers.

In the preferred embodiments of the invention, the or each roller is adapted to float laterally (i.e. in a direction perpendicular to that in which material flows through the nip) against a resilient bias which urges it towards the other roller. Preferably, one of the rollers is fixed and the other is adapted to float laterally. The/each resilient bias may, consistent with typical high pressure grinding roll applications, by provided, for example, by a hydro-pneumatic spring.

In a preferred embodiment of the invention, the rollers rotate asynchronously. For example, they may be operated at different angular velocities (which may be uniform or time-varying), subjected to different angular accelerations, be operated in a stepped manner and/or intermittently (e.g. whereby the rollers are operated in a cyclic manner wherein, in each cycle, one roller is driven while the other is not, then vice versa).

In a preferred embodiment of the invention, the rollers may be synchronously operated in a stepped or intermittent manner.

Preferred embodiments of the invention invoke two underlying phenomena in processing of material, including in particular granular matter, and solid-liquid separation, namely: (1) the effect of simultaneous shear on compressive dewatering processes, and (2) buckling and breaking of force chains within the material.

With respect to phenomenon (1), the addition of shear during compressional dewatering processes significantly reduces the pressure required to consolidate the material at a given rate or increases the rate at a given applied pressure (Stickland A D and Buscall R, 2009, Whither compressional rheology J. Non-Newtonian Fluid Mech., 157(3): 151; Channell G M, PhD Thesis: Mechanics of aggregated alumina suspensions: behavior under shear and compression, The Department of Chemical Engineering. 2000, University of Illinois: Urbana-Champagne; Gladman B, de Kretser R G, Rudman M and Scales P J, 2005, Effect of shear on particulate suspension dewatering, Chem. Eng. Res. Des., 83(A7): 933, the contents of which are hereby incorporated herein by reference in their entirety). The effect is evident in many industrial processes, such as belt press filters, decanting centrifuges and raked thickeners, but the understanding to date has been purely empirical. Preferred embodiments of the present invention apply an appropriate balance of shear and compression in order to achieve optimum moisture reduction for a given throughput, which will vary according to a number of factors, and can be determined on a case-by-case basis without inventive input. The invention may be embodied in apparatuses and methods which provide high throughputs.

With respect to phenomenon (2), when matter, especially granular matter, is subjected to a compressive load, a small fraction of the particles self-organise to form force chains that bear the applied load (Peters J F, Muthuswamy M, Wibowo J and Tordesillas A, 2005, Characterization of force chains in granular material, Phys. Rev. E, 72(4): 041307; Tordesillas A and Muthuswamy M, 2009, On the modeling of confined buckling of force chains, J. Mech. Phys. Solids, 57(4): 706, the contents of which are hereby incorporated herein by reference in their entirety). These interlocking columns of particles store the strain energy and release the energy either by breaking (by way of comminution or buckling (in which case the applied load has not been expended in breaking the particles). Preferred embodiments of the invention eliminate much of the energy wasted in forming, buckling and breaking force chains.

The inventors have invented specific advantageous methodologies and apparatuses for comminution and/or removal of liquid from a material, which invoke phenomena (1) and (2).

In the preferred embodiments of the invention, the material comprises bulk material.

The shearing, generally speaking, will be effected in a direction generally parallel to a direction in which the material flows through a region between the rollers.

In a preferred embodiment of the invention, the rollers are operated such that there is a difference in surface speeds thereof, whereby said shearing is effected. For example, the rollers may be of substantially the same diameter and rotated at different rotational speeds, or of different diameter and rotated at substantially the same rotational speed, to effect shearing.

In the, preferred embodiments of the invention, a pressurised charge/stock of the material is provided at an inlet end of the pair of rollers, and the material is drawn between the rollers directly from the charge/stock. Preferably, the rollers are arranged generally side-by-side and the material is drawn downwardly therebetween. The charge/stock may thus be arranged above a nip defined between the rollers and pressurised under a head pressure therein, whereby intake of the material between the rollers may be gravity-assisted. Intake of the material may, alternatively or additionally, be feed roller-assisted.

In one preferred embodiment of the invention, the rollers are of the same diameter and rotated at different angular velocities (whereby speeds of opposed compaction surfaces which compress the material differ and shearing is thus induced). In such an embodiment, the charge/stock may be arranged uniformly/symmetrically about a plane, which may be a central plane, which extends through the nip and parallel to the direction of flow of the material through the nip. Alternatively, the charge/stock may be arranged non-uniformly/asymmetrically about the plane.

In another preferred embodiment of the invention, the rollers are of different diameters and rotated at the same angular velocity (whereby, again, speeds of opposed compaction surfaces which compress the material differ and shearing is thus induced). In such an embodiment, axes of rotation of the rollers may lie in a plane which is perpendicular to the direction of flow of material through the nip. Alternatively, those axes may lie in a plane which is generally transverse, though not perpendicular, to the direction.

In a preferred embodiment of the invention, the charge/stock is supported against at least one of the rollers, and preferably both of the rollers. The roller(s) against which the charge/stock is supported may assist in drawing of the material between the rollers.

In the preferred embodiments of the invention, the rollers comprise high pressure grinding rolls.

In the preferred embodiments of the invention, the material comprises both a solid component and a liquid component and the simultaneous shearing and compaction promotes/enhances separation of liquid from the material. In a particularly preferred embodiment of the invention, the liquid comprises water, and the simultaneous shearing and compaction promotes/enhances dewatering of the material.

The material may comprise biomass or mined/carbonaceous material, which may comprise any of a range of materials, including low rank coals, peat, lignite, brown coal, subbituminous coal, other carbonaceous solids or derived feedcharge/stock. In a particularly preferred embodiment of the invention, the material comprises brown coal.

In the preferred embodiments of the invention, the method is, or forms part of, a beneficiation and/or dewatering method.

The material may be unprocessed, or alternatively may have been pre-processed, e.g. by a beneficiation procedure such as thermal drying, washing, biological/chemical beneficiation, dry screening or wet screening.

The material may be subjected to post-processing following application of the method according to the invention thereto.

In the preferred embodiments of the invention, the material may be subjected to a compaction pressure between the rollers of, for example, between about 3,000 psi and about 80,000 psi. More specifically, the compaction pressure may be between about 20,000 psi and about 60,000 psi. More specifically still, the compaction pressure may be about 40,000 psi.

In a preferred embodiment of the invention, the rollers are operated in an asynchronous manner to induce an appropriate shear and compressive regime for more efficient comminution. Likewise, the operation may induce improved solid-liquid separation.

The rollers may also be rotated in an intermittent and/or stepped manner.

The rollers may each contact the material. Alternatively, a belt may be trained around either or each roller, the belt providing the compaction surface, whereby that roller engages the material indirectly. The or each belt/compaction surface may assist in drawing of the material between the rollers.

According to a second aspect of the present invention, there is provided an apparatus, including said pair of rollers, operable to effect a material processing method as defined above.

The apparatus preferably further includes a feed reservoir adapted to hold said charge/stock.

Perhaps surprisingly, shearing may be optimised where the unevenness, non-uniformity or asymmetry of the draw is slight.

The apparatus may also include, and/or the method may also employ, pressure feeding rolls to assist drawing of the material between the rollers.

The invention will now be described, by way of non-limiting example only, with reference to the accompanying drawings in which:

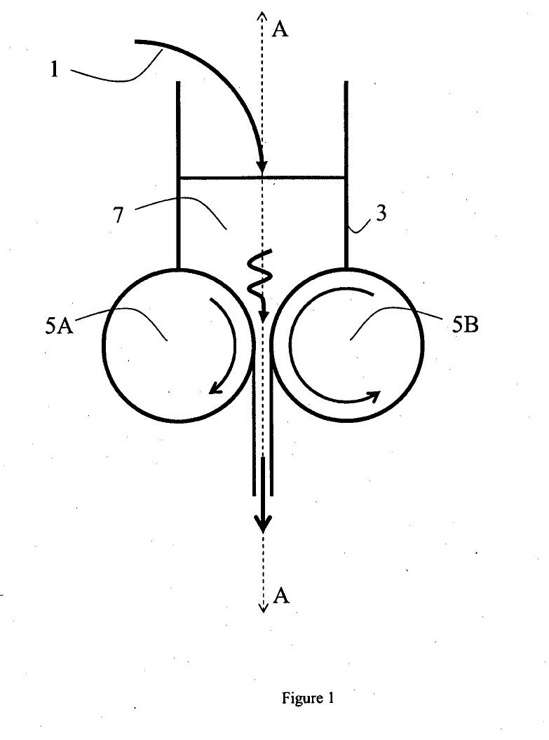

FIG. 1 is a schematic view depicting a material processing method according to a first preferred embodiment of the present invention;

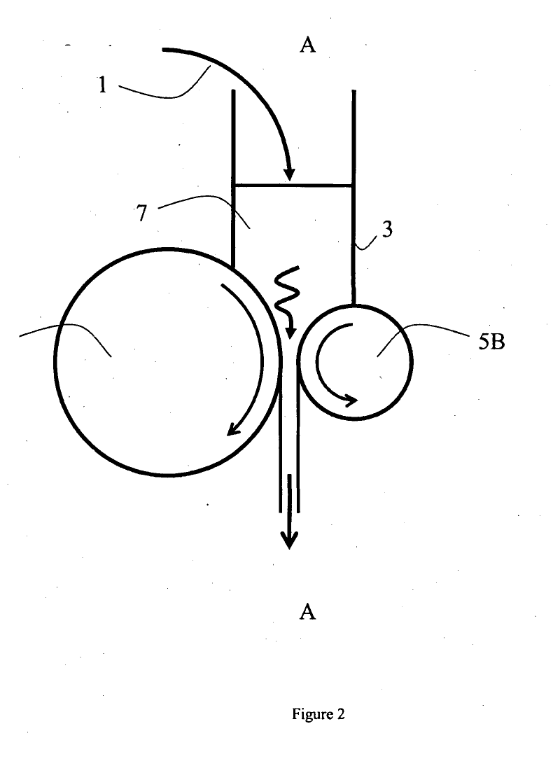

FIG. 2 is a schematic view depicting a material processing method, according to a second preferred embodiment of the present invention;

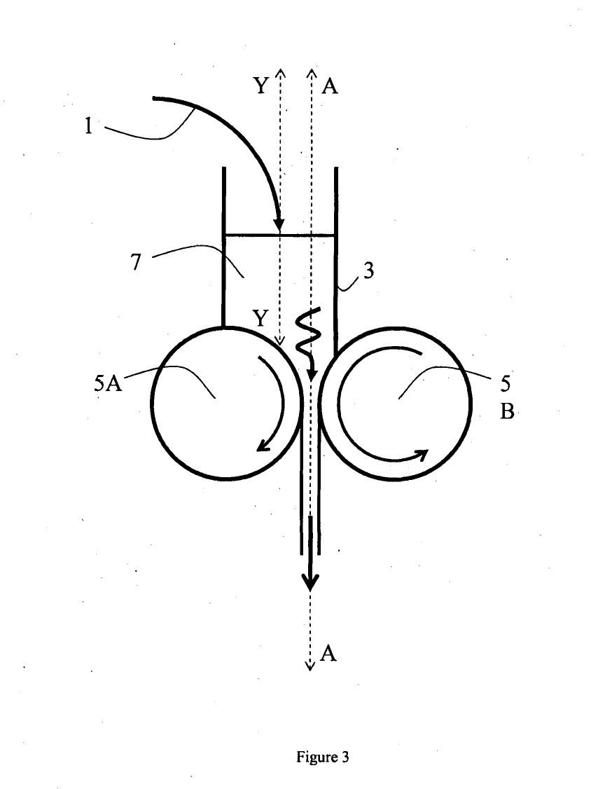

FIG. 3 is a schematic view depicting a material processing method according to a third preferred embodiment of the present invention;

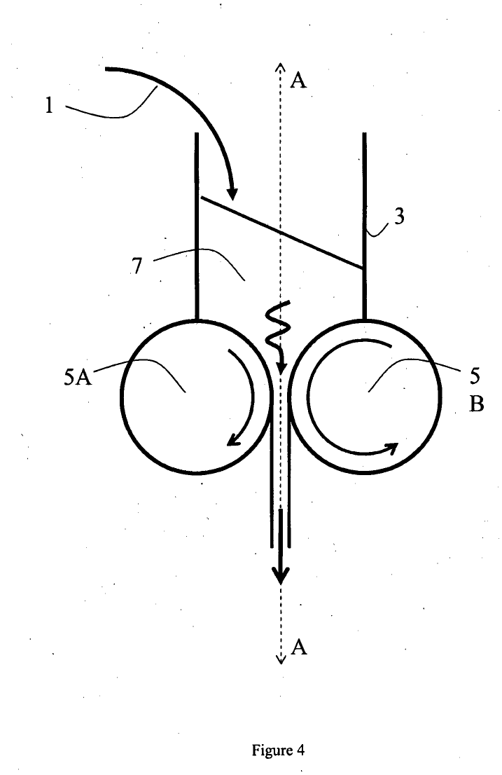

FIG. 4 is a schematic view depicting a material processing method according to a fourth preferred embodiment of the present invention;

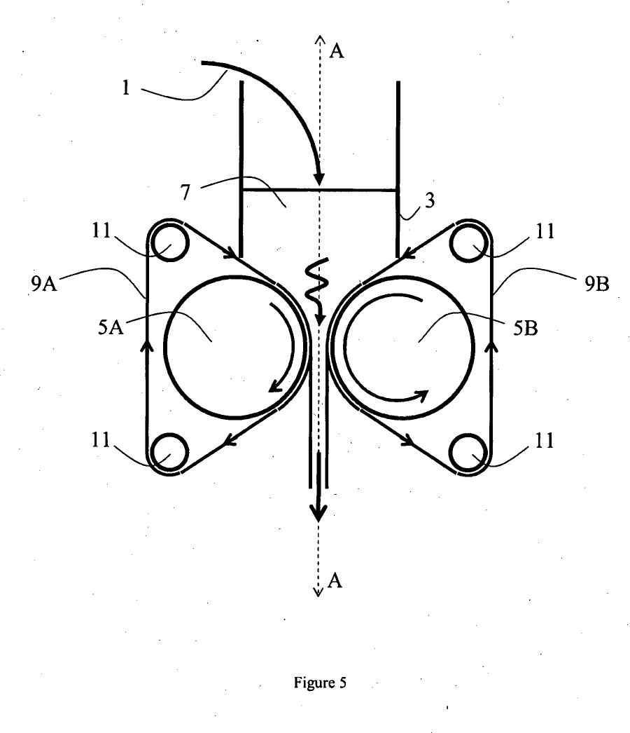

FIG. 5 is a schematic view depicting a material processing method according to a fifth preferred embodiment of the present invention;

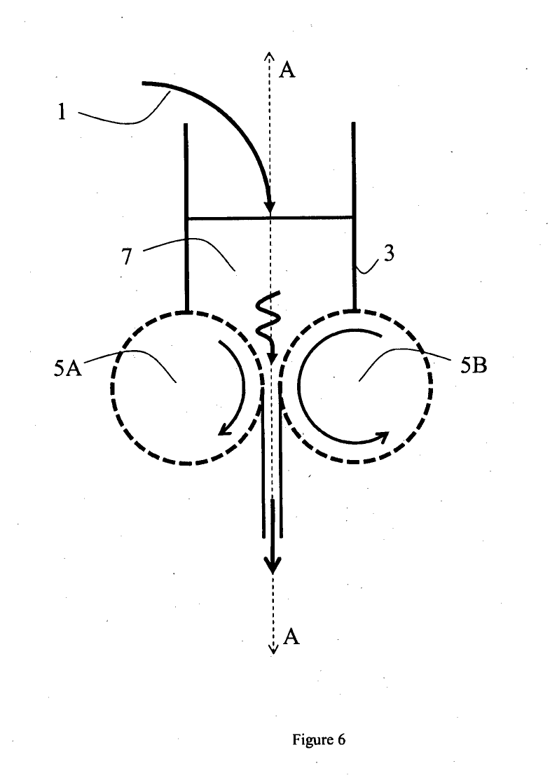

FIG. 6 is a schematic view depicting a material processing method according to a sixth preferred embodiment of the present invention; and

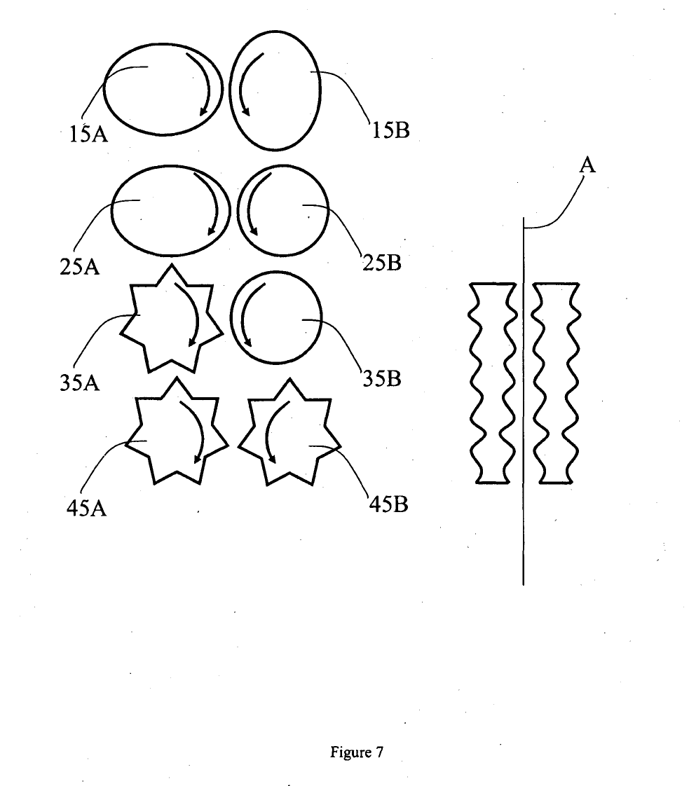

FIG. 7 is a schematic view depicting alternative roller configurations any of which may instead be employed in any of the embodiments described herein with reference to FIGS. 1 to 6.

Alternative processes for comminuting and/or dewatering material, particularly bulk material, according to preferred embodiments of the present invention will now be described in detail with reference to FIGS. 1 to 7. In the described embodiments, the bulk material comprises brown coal, which is comminuted by compaction and dewatered via the method, but the invention has application to other material.

Referring firstly to FIG. 1, in an upgrading process according to a first preferred embodiment of the invention, the bulk material 1 to be processed is fed into a feed unit or reservoir 3, which may comprise a chute, hopper or surge bin. The feed unit 3 is centrally disposed over a pair of counter-rotating high pressure grinding rollers 5A, 5B which in the present embodiment have the same diameter. The interior of feed unit 3 is symmetrical about central plane A, which may be a vertical plane, and the axes of rotation of the rollers 5A, 5B are spaced the same distance to either side of the plane A and arranged at the same level relative to that plane. The feed unit 3 is open at a lower end thereof whereby bulk material which has accumulated in the feed unit 3, can be drawn between the rollers 5A, 5B and thus compacted thereby, within a nip defined therebetween (the nip, as is known in the art, being the location at which the separation between the moving surfaces which contact the material is a minimum). The bulk material- 1 is fed into the feed reservoir 3 at a rate which is such that it forms a charge or charge/stock 7 of the material which is located above the nip and rests against upper parts of the rollers 5A, 5B. The charge/charge/stock 7 in this embodiment, the lower end of which is defined by the rollers on which it rests, has a configuration which is symmetrical about plane A, owing to the symmetrical configuration of the reservoir 3 and rollers 5A, 5B about the plane and the fact that its exposed/upper surface assumes a uniform/flat level in the reservoir.

In the present embodiment, the rollers 5A, 5B are rotated at different rotational speeds such that the bulk material which is drawn therebetween (under the assistance of gravity and/or possibly feed rolls) is subjected not only to compression in the direction between the roller axes of rotation (which direction is horizontal in the examples shown) but additionally subjected to shearing in a direction generally parallel to plane A. Owing to the formation of charge/stock 7, there is a pressurised feed of the bulk material 3 to the rollers 5A, 5B. It may be desirable that the difference in rotational speed/angular velocity of the rollers be slight (e.g less than 5%, and perhaps about 1%) for shearing to be optimised.

The shearing, which in this embodiment is created by rotating the rollers 5A, 5B at different speeds, can reduce the energy output required for comminution of the material and simultaneously enhance dewatering.

The material may be output from the nip in alternative forms, including, for example, a ribbon-like form, which may be loosely formed/connected, the form of separate pieces, and/or the form of discrete particles or clumps, or a form which intermediate or a combination of any of the foregoing.

In the forthcoming description of the further embodiments of the invention, the same reference numerals as have been used in relation the first embodiment will, where appropriate, be used to denote and refer to the same or corresponding features.

Referring to FIG. 2, an upgrading process according to a second preferred embodiment of the invention is similar to that of the first embodiment except that the diameter of roller 5A is larger than that of roller 5B whereby there is effected the difference in speeds of the surfaces of the rollers 5A, 5B and thus the shearing of the material compressed between the rollers 5A, 5B, in a direction generally parallel to plane A. The axes of rotation of the rollers 5A, 5B are at the same level with respect to plane A and equally spaced therefrom. Opposed interior side walls of the feed reservoir 3 are similarly equally spaced to either side of the plane A. As a result of the difference in roller diameters, the charge/stock lower end, or interface between the reservoir 3 and roller pair is, unlike that in the first embodiment, asymmetrical about plane A. This asymmetry may promote the shearing in the material being compressed and thus further improve the comminution and/or dewatering efficiency. The rollers 5A and 5B may be rotated at the same angular velocities or different angular velocities.

Referring to FIG. 3, an uprading process according to a third preferred embodiment of the present invention is similar to that of the first embodiment, though the same-diameter rollers 5A, 5B are rotated at the same angular velocity or different angular velocities, and a central plane Y of the reservoir 3, which is parallel to plane A, is laterally offset from that plane. In this embodiment, the charge/stock lower end/interface between the reservoir 3 and roller pair is not symmetrical about the plane A. As a result, the draw of material into the region between the rollers 5A, 5B is uneven about plane A, whereby shearing is effected in the material as it is compressed between the rollers, in a direction generally parallel to plane A. The rollers 5A, 5B in the arrangement shown in FIG. 3 may, in a variation from this embodiment (which also falls within the scope of the invention), be rotated at different angular velocities.

An upgrading process according to a fourth preferred embodiment of the present invention is shown schematically in FIG. 4. In this embodiment, the rollers 5A, 5B are of the same diameter, have axes of rotation at the same level with respect to plane A and rotate at the same or a different angular velocity. The reservoir 3 is centrally disposed with respect to plane A (consistent with the first embodiment). In this embodiment, however, the uneven draw about plane A, of the material into the region between the rollers 5A, 5B is attributable, at least in part, to the charge/stock 7 having a configuration which is uneven or asymmetrical about plane A, such that there is an asymmetric pressure profile about the plane A at the charge/stock lower end. More particularly, the depth of the charge/stock 7 varies such that the charge/stock. 7 is not symmetrical about plane A. In the examples shown, the charge/stock 7 is configured such that its exposed/upper surface is sloped with respect to plane A, so as to be inclined in a direction from one side wall of the reservoir 3 to the other. Whilst, in the example shown, the level of the upper surface increases linearly in that direction, other embodiments are possible in which the variation in level is non-linear. The draw of uneven/asymmetric/non-uniform draw of material into the region between the rollers 5A, 5B gives rise to shear in the material as it is compressed between the rollers, in a direction generally parallel to plane A, whereby, again, efficiencies may be increased as outlined previously. The rollers 5A and 5B, in a variation from this embodiment which is within the scope of the invention, are of different diameters to promote effective shearing.

With reference to FIG. 5, a process for upgrading bulk material according to a fifth preferred embodiment of the present invention is similar to that of the first embodiment, in that the arrangement comprising the reservoir 3 the charge/stock 7 of material 1 and the rollers 5A, 5B is symmetrical about plane A and the rollers 5A, 5B are rotated at different angular velocities, though in this embodiment, that arrangement is additionally provided with a pair of endless belts 9A, 9B which are trained over rollers 5A, 5B respectively and engage them so as to transfer drive to the rollers or be driven by the rollers. Each belt 9A, 9B is trained also around an arrangement of idler rollers 11 whereby it follows a circuitous track as the respective roller 5A, 5B rotates. The belts 9A, 9B are arranged symmetrically about plane A and operate to draw the material 1 into the region between the rollers 5A, 5B. Because the speed of one belt exceeds that of the other, the belt-assisted draw of material into the region between the rollers 5A, 5B is non-uniform or asymmetric about plane A, giving rise to shear in the material as it is compressed between the rollers 5A, 5B, in a direction generally parallel to plane A, resulting in more efficient comminution and/or liquid removal. In a variation from this embodiment which falls within the scope of the invention, the rollers 5A, 5B may instead be of different diameters, the reservoir 3 may be non-centrally/asymmetrically disposed about plane A, the pile 7 may be non-uniform (e.g. consistent with the fourth embodiment).

With reference to FIG. 6, an upgrading process for bulk material according to a sixth preferred embodiment of the invention is the same at that of the first embodiment except that the compaction surfaces comprise a modification, which may, for example, be axially symmetric, radially symmetric or helical around the roller. The compaction surfaces in this embodiment, and/or in any of the preceding embodiments, may also be configured to aid removal of moisture during solid-liquid separation; for example the compaction surfaces may be porous. Liquids may be removed from the compaction surfaces by one or more scraper blades. Alternatively or additionally, the rollers may be configured such that they wick, via the porous compaction surfaces, liquid away from the material.

A variation from any one of the previously described embodiments which falls within the scope of the invention involves the roller/reservoir/charge/stock arrangement as illustrated in respect of that embodiment though intermittent or stepped-in-time rotation of one or both of the rollers, such that the rollers move asynchronously. This variation is particularly beneficial in improving the efficiency of dewatering.

As a result of the formation of a charge/stock 7 in each embodiment, which may assume a substantially constant configuration, substantially steady-state conditions may be established in the reservoir 3.

In each of the described embodiments, the charge or stock of material may be maintained substantially constant, whereby the process is continuous, or instead depleted and replenished, whereby the process is a batch process (i.e. the steps of the reservoir being filled and the charge/stock then being drawn down could be repeated).

In each embodiment, the material is being subjected to both comminution (comprising particle/granule size reduction) and compaction (reduction of voidage within the material).

In the preferred embodiments of the invention (including all of the embodiments described previously with reference to FIGS. 1 to 6), one roller is adapted to float laterally (i.e. in a direction perpendicular to that in which material flows through the nip) against a resilient bias which urges it towards the other roller, consistent with high pressure grinding roll applications known in the art. These preferred embodiments include arrangements in which either or each of the rollers in the roller pair is not cylindrical. Examples of roller pairs, any one of which could be substituted for the roller pair in any one of the embodiments described previously with reference to FIGS. 1 to 6, are shown in the left-hand side of FIG. 7. In the first example, there are provided rollers 15A, 15B which are elliptical in section and which are rotationally orientated 90 degrees out of phase. In the second example, there are provided rollers 25A and 25B which have elliptical and circular, respectively, cross sections. In the third example, there are provided rollers 35A and 35B which have star-shaped and circular, respectively, cross sections. In the fourth example, there are provided rollers 45A and 45B which both have star-shaped cross sections.

In each of the embodiments described thus far, the width of the nip is substantially constant throughout the length of the nip/rollers. However, it is possible, without departure from the invention, for the nip width to vary along that length, for example in the fluctuating/cyclic manner, including that shown in the right-hand side of FIG. 7, and/or in other manners, including a progressively increasing manner.

Although in the embodiments in which rotation of the rollers is stepped and/or intermittent to effect shearing, that rotation is preferably asymmetric/asynchronous between the rollers. Rotation of the rollers in a stepped or intermittent manner, whether asymmetrically/asynchronously or not, may be desirable generally, and be a variant of any of the embodiments previously described, which variant would also embody the invention, to aid dewatering.

The shearing can reduce the energy output required for comminution of and/or removal of liquid from the material.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

1. A material processing method wherein a material is fed between a pair of opposed moving surfaces which converge such that a nip is defined there between, whereby the material is drawn into the nip to be compressed or compacted between the surfaces, and thence output from between the surfaces, the method comprising subjecting the material to an asymmetric and/or non-uniform flow condition between the surfaces to effect shearing in the material in a direction generally parallel to the direction of flow of the material between the surfaces.

2. A material processing method wherein a material is fed between a pair of opposed moving surfaces which converge such that a nip is defined there between, so that the material is compressed or compacted between the surfaces, and thence output from between the surfaces, and wherein a draw of the material into the nip is uneven about a plane through the nip extending parallel to a direction of flow of the material between the surfaces, to effect shearing in the material.

3. The method according to claim 1, wherein the shearing is effected in a direction generally parallel to the direction of movement of the surfaces at the nip.

4. The method according to claim 1, wherein the asymmetric and/or non-uniform flow condition or uneven draw is effected by a difference in speed of the surfaces.

5. The method according to claim 1, wherein the asymmetric and/or non-uniform flow condition or uneven draw is effected by a difference between configurations of the surfaces.

6. The method according to claim 1, wherein the asymmetric and/or non-uniform flow condition or uneven draw is effected by a difference in a hydrostatic pressure and/or density profile in the material in a direction from about which one of the surfaces is circuited/circulated/cycled and an axis about which the other of the surfaces is circuited.

7. The method according to claim 1, wherein the asymmetric and/or non-uniform flow condition or uneven draw is effected by asynchronous movement of the surfaces.

8. The method according to claim 1, wherein the asymmetric and/or non-uniform flow condition or uneven draw is effected by stepped and/or intermittent movement of the surfaces.

9. The method according to claim 1, wherein the asymmetric and/or non-uniform flow condition or uneven draw is effected by a stock or charge of material being forced in an even manner against the surfaces adjacent/at an inlet to the nip.

10. The method according to claim 1, wherein the is a central plane through the nip.

11. The method according to claim 1, wherein the surfaces are symmetrically arranged about a central plane passing through the nip.

12. The method according to claim 11, wherein the surfaces move asynchronously and/or at different speeds.

13. The method according to claim 1, wherein the material is drawn between opposed counter-rotating rollers.

14. The method according to claim 13, wherein said surfaces comprise surfaces of the rollers.

15. The method according to claim 13, wherein said surfaces comprise surfaces of belts which are trained around the rollers.

16. The method according to claim 14, wherein at least one of the rollers is adapted to float laterally against a bias which urges it towards the other roller.

17. The method according to claim 14, wherein the rollers rotate asynchronously.

18. The method according to claim 14, wherein the rollers are rotated at different angular velocities.

19. The method according to claim 14, wherein the rollers are subjected to different angular accelerations.

20. The method according to claim 14, wherein the rollers are operated in a stepped manner and/or intermittently.

21. The method according to claim 14, wherein the rollers are operated such that there is a difference in surface speeds thereof

22. The method according to claim 14, wherein the rollers are of substantially the same diameter.

23. The method according to claim 14, wherein the rollers are of different diameters.

24. The method according to claim 14, wherein the rollers are rotated at substantially the same rotational speed.

25. The method according to claim 14, wherein the rollers are rotated at different rotational speeds.

26. The method according to claim 1, wherein the material comprised bulk material.

27. The method according to claim 1, wherein a pressurised charge or stock of the material is provided at an inlet end to a region between the surfaces, whereby material is drawn between the surfaces directly from the charge/stock.

26. The method according to claim 1, wherein the surfaces are arranged in generally side-by-side relation and the material is drawn downwardly therebetween.

27. The method according to claim 26, wherein the charge or stock is pressurised under a head pressure therein, whereby intake of the material between the surfaces is gravity-assisted.

28. The method according to claim 1, wherein the/a charge or stock of the material is arranged uniformly/symmetrically about a plane which extends through the nip and parallel to the direction of flow of the material through the nip.

29. The method according to claim 1, wherein the charge/stock is arranged non-uniformly/asymmetrically about the plane.

30. The method according to claim 1, wherein axes about which said surfaces are circuited/rollers rotate lie in a plane which is perpendicular to the direction of flow of material through the nip.

31. The method according to claim 1, wherein the/a charge or stock of the material is supported against at least one of the surfaces/rollers.

32. The method according to claim 1, wherein the charge or stock is supported against both of the rollers.

33. The method according to claim 31, wherein the or each of the surfaces/rollers against which the charge/stock is supported assists in drawing of the material between the surfaces/rollers.

34. The method according to claim 1, wherein the material is drawn between high pressure grinding rolls which define said rollers/surfaces.

35. The method according to claim 1, wherein the material comprises both a solid component and a liquid component and simultaneous shearing and compaction of the material between the surfaces promotes/enhances separation of liquid from the material.

36. The method according to claim 35, wherein the liquid comprises water, and the simultaneous shearing and compaction promotes/enhances dewatering of the material.

37. The method according to claim 1, wherein the material comprises any one or more of the following: biomass; mined/carbonaceous material; low rank coals; peat; lignite; brown coal; subbituminous coal; carbonaceous solids; and derived feedcharge/stock.

38. The method according to claim 1, the method being, or forming part of, a beneficiation and/or dewatering method.

39. The method according to claim 1, wherein the material is as input between the surfaces is unprocessed.

40. The method according to claim 1, wherein the material is as input between the surfaces has been pre-processed.

41. The method according to claim 1, the method being one which is followed by post-processing of the material.

42. The method according to claim 1, wherein the material is subjected to a compaction pressure between the surfaces of between about 3,000 psi and about 80,000 psi.

43. The method according to claim 42, wherein the compaction pressure is between about 20,000 psi and about 60,000 psi.

44. The method according to claim 43, wherein the compaction pressure is about 40,000 psi.

45. An apparatus, which includes said surfaces/rollers and which is operable to effect a material processing method as defined above.

46. The apparatus according to claim 45, including a feed reservoir adapted to hold a/the charge or stock of material.
